(19) United States
(12) Patent Application Publication
(10) Pub. No.: US 2015/0009031 A1
(43) Pub. Date: Jan. 8, 2015

(54) MULTILAYER PERIMETER INSTRUSION DETECTION SYSTEM FOR MULTI-PROCESSOR SENSING

(71) Applicant: Honeywell International Inc., Morristown, NJ (US)

(72) Inventors: Saad J. Bedros, West St. Paul, MN (US); Mahesh K. Gellaboina, Andhra Pradesh (IN); Lalitha M. Eswara, Bangalore (IN)

(21) Appl. No.: 13/935,022

(22) Filed: Jul. 3, 2013

(51) Int. Cl. G08B 13/16

(52) U.S. Cl. CPC G08B 13/16
USPC 340/566

(57) ABSTRACT

A system includes perimeter intrusion detection sensors and a computer processor communicatively coupled to the perimeter intrusion detection sensors. The system receives data from the perimeter intrusion detection sensors, fuses the data from the perimeter intrusion detection sensors, and generates a single alarm from the fused data when the fused data indicates a breach of an area associated with the perimeter intrusion detection sensors. A sensor fusion framework for accomplishing these tasks is described.

### TECHNICAL FIELD

The present disclosure relates to perimeter intrusion detection systems using multiple sensors, and in an embodiment, but not by way of limitation, a multi-sensor perimeter intrusion detection system that associates data by using uncertainty characteristics in time and space.

### BACKGROUND

Security and safety of critical infrastructures are a high priority for a company and/or a country. Critical infrastructures include such things as petroleum refineries, stock exchanges, chemical factories, airports, harbors, military headquarters, railway stations, and nuclear power plants. Currently, video and/or RADAR-based solutions are most commonly used for monitoring these infrastructures. In some instances, fence sensors, microwave barriers, and infrared barriers are also used to safeguard the sensitive areas. Perimeter Intrusion Detection Systems (PIDS) can play a vital role in critical infrastructure protection. While in such systems it is cost effective to monitor the long perimeters using individual sensors like cameras, RADAR, microwave barriers, infrared (IR) barriers, and fence sensors, these sensors typically suffer from nuisance false alarms, thereby making the whole system unreliable.

### BRIEF DESCRIPTION OF THE DRAWINGS

FIG. 1 is a block diagram of an example embodiment of a perimeter intrusion detection system.

FIG. 2 is a block diagram of another example embodiment of a perimeter intrusion detection system.

FIG. 3 is a flow chart of an example embodiment of a data association operation.

FIG. 4 is a diagram illustrating the spatial uncertainty of different scenarios.

FIG. 5 is a diagram illustrating the spatial uncertainty of cameras.

FIGS. 6A, 6B, and 6C are diagrams illustrating overlapping scenarios.

FIG. 7 is a flow chart of an example embodiment of a gate-based data association operation.

FIG. 8 is a flow chart of an example embodiment of a probabilistic-temporal data association operation.

FIG. 9 is a flow chart of an example embodiment of a probabilistic-spatial data association.

FIG. 10 is a diagram of a simulated layout of a perimeter intrusion detection system.

FIG. 11 is a diagram of a close-up view of the simulation layout of FIG. 10.

FIG. 12 is an example of an association matrix.

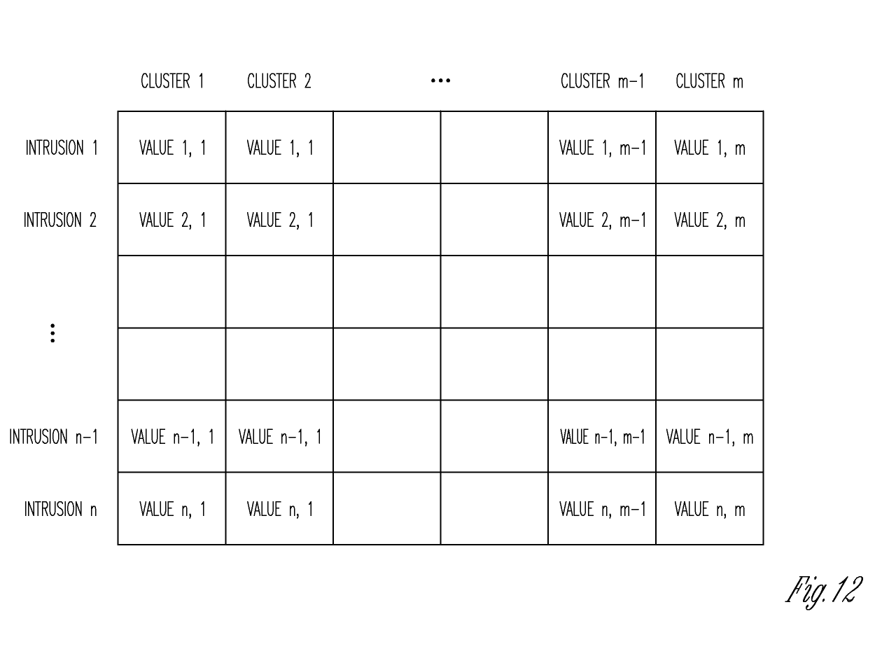

FIG. 13 is an example embodiment of a rule based engine.

FIG. 14 is a flow chart of an example embodiment of a rule based process.

FIG. 15 is a flow chart of a log likelihood computation.

FIG. 16 is a flow chart of an example embodiment of another rule based process.

FIG. 17 illustrates a method that can be used for an event detection module in a perimeter intrusion detection system.

FIG. 18 is a block diagram of a computer system upon which one or more disclosed embodiments can execute.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, electrical, and optical changes may be made without departing from the scope of the present invention. The following description of example embodiments is, therefore, not to be taken in a limited sense, and the scope of the present invention is defined by the appended claims.

As noted above, Perimeter Intrusion Detection Systems (PIDS) can at times be unreliable. To address this unreliability, an embodiment effectively fuses or combines information from multiple and different types of sensors and creates a single alarm instead of multiple alarms. The single alarm results in a more effective system, which reduces the burden on the security operator in the control room and also reduces nuisance alarms. However, fusing multiple sensor readings has different challenges. Each sensor can have different performance characteristics, different response times, and different coverage areas (i.e., overlapping or non-overlapping with other sensor coverage areas). A challenge therefore is to associate the sensor readings at different monitored ranges of the perimeter and analyze the associated readings for more effective decision making. One embodiment focuses on providing a novel sensor fusion framework for PIDS, given the multitude of sensors described in this disclosure.

In an embodiment, a multilayer perimeter protection system supports multiple, different types of sensors to provide robust security. Many times in perimeter security systems, one sensor is complementary to another sensor. Consequently, the information from multiple different types of sensors is combined and a single alarm is created instead of multiple alarms, thereby reducing the burden on the security operator in the control room and also reducing nuisance alarms. The system embodiment focuses on fusing the alarms from multiple sensors so that the nuisance alarms are mitigated to a large extent and actual alarms are sent to the control station. An operation in a fusion of multiple sensor readings is data association, which needs to take sensor characteristics and spatial and temporal uncertainties into consideration, and which gives an alarm with high confidence.

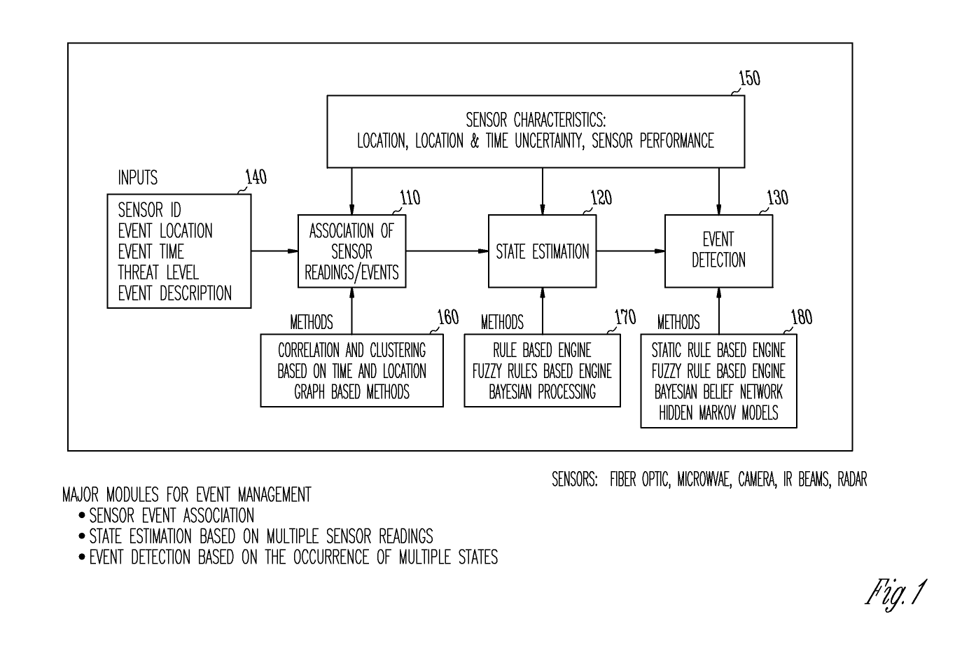

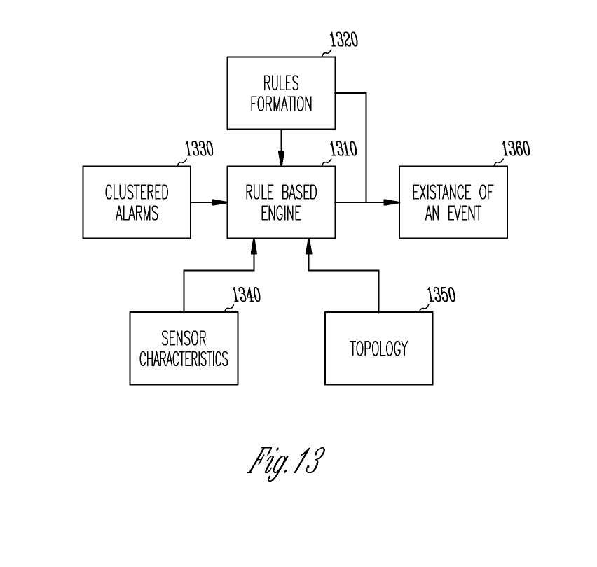

FIG. 1 illustrates an example of a perimeter intrusion detection system. The system of FIG. 1 is comprised of three layers. The first layer at 110, association of multiple sensor readings happen. The association module primarily focuses on correlation and clustering of individual sensor readings/events. The second layer at 120 provides a state estimation. The third layer at 130 makes an event detection decision. In the first layer 110 receives input from a multitude of sensors at 140. This input can include the sensor ID, the event location, the event time, the threat level, and the event description. The first layer 110 also receives as input at 160 a correlation and clustering of sensor input. This correlation and clustering can be based on time and location graph methods, and takes into account uncertainty of sensor readings. At each layer, the system takes into account the sensor characteristics 150 such as where the sensor is placed, the mapping of the sensor to the global coordinate system, and the sensor analytics performance. The state estimation module gives first level decision system based on the clustered or associated sensor readings/events from 110. Some of the methods used for State estimation modules are a rule based engine, a fuzzy rules based engine, and Bayesian processing based methods and evidence based methods (170). The state estimation 120 analyzes each of the associated sensor reading clusters to determine if a true intrusion occurred. The state estimation 120 is described in more detail below in connection with FIGS. 13, 14, and 15. The event detection 130 generates an event detection decision using methods such as a static rule based engine, a fuzzy rule based engine, a Bayesian belief network, and hidden Markov models (180). In general, the event detection 130 analyzes the detection of multiple simple events that are output from State Estimation, to determine a complex intrusion activity occurrence or situation awareness that is brought to the attention of the security officer at a high or higher alarm level.

An embodiment can be integrated with other perimeter and/or multi-sensor systems, and can evaluate clusters to provide a more intelligent decision regarding suspected intrusions. The system can also take advantage of deploying less expensive complementary sensors that can be combined to provide a more robust solution. The system can be used in connection with building solutions products, radar-video surveillance systems that are used for critical infrastructure protection, and scenarios wherein multiple sensors are used for perimeter protection. Applications that particularly benefit from, and which may indeed require, data association from multiple sensors include marine applications, airport security, and nuclear power plant security.

Nuisance alarms are mitigated to a large extent via a robust spatio-temporal data association method that takes into account sensor characteristics as uncertainties in spatial and temporal domains by spatial mapping and sensor analytics. The association process includes several operations. A temporal gate is adaptively computed based on each type of sensor (e.g., video versus infrared camera), and a spatial gate is adaptively computed based on sensor type. The distance between readings is computed using spatial and temporal uncertainty for gating-based association. The probability of the nearness between two readings is computed using spatial and temporal uncertainties for the probability-based data association. The spatial uncertainty of the object is computed based on the location of the object in the field of view of the sensor (e.g., RADAR, visual camera, and fence). Temporal uncertainty is then computed based on the sensor type. Spatio-temporal data is then associated by taking uncertainties in the spatial and temporal data and the sensor characteristics. Finally, metrics are formulated for data association in the context of multi-sensor alarm fusion.

In current perimeter and/or multiple sensor systems, a focus is on how one can effectively use individual sensor performance better rather than making use of multiple sensors. Each sensor has its own advantage, and all the sensors can be complementary to each other to some extent. For example, during heavy winds a fence sensor could generate a false alarm, but a RADAR and/or video system would not generate such a false alarm during high winds. Consequently, it would be beneficial for a perimeter and/or multi-sensor system to have a unified framework that can fuse the readings from multiple sensors and generate alarms which are accurate and reliable in the vast majority of the cases. Such a system would reduce nuisance alarms, which are of high concern to the operator sitting in the control room. Generally, such a multi-sensor fusion would need efficient data association algorithms for combining the readings from multiple sensors.

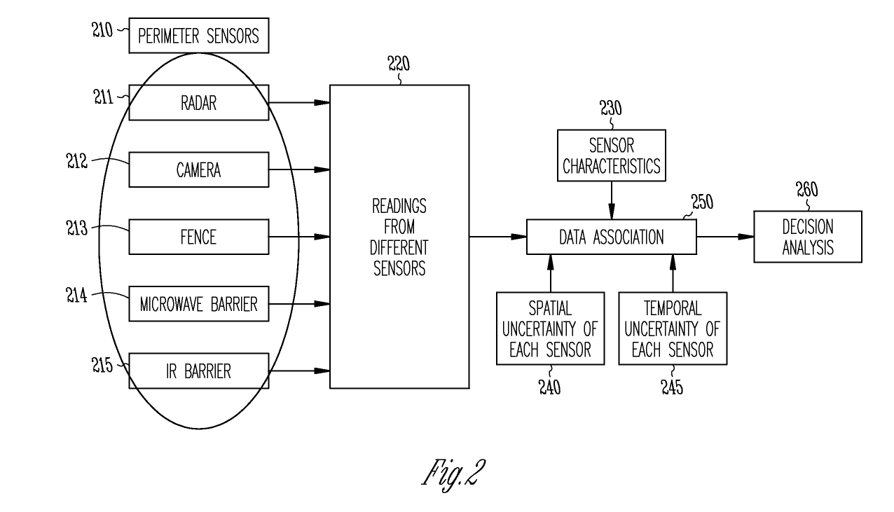

FIG. 2 illustrates another embodiment of a perimeter intrusion detection system. The system of FIG. 2 involves the use of one or more sensors 210 such as RADAR (211), camera (212), vibration sensor on a fence (213), microwave barrier (214), and IR barrier (215) for monitoring the perimeter. All of these different types of sensors have different coverage areas, different delays in sending responses to a central station, and are installed at different locations relative to the perimeter.

The embodiment of FIG. 2 receives readings from the different sensors at 220, and at 250, associates the readings provided by the multiple sensors. This association considers sensor characteristics 230, spatial uncertainty 240, and temporal uncertainty 245. The associated data is then provided to a decision analysis module 260 (State Estimation 120). Each type of sensor has different coverage regions and response times. For example, RADAR covers a relatively large area compared to microwave barriers or IR barriers. Also, an object can be seen for a relatively long period of time in a radar region as compared to microwave, IR, and fence barriers because the coverage of microwave, IR, and fence barriers is limited. However, the response times of microwave, IR, and fence barriers are very fast compared to radars and cameras. This is due to analytics that run on radars and cameras.

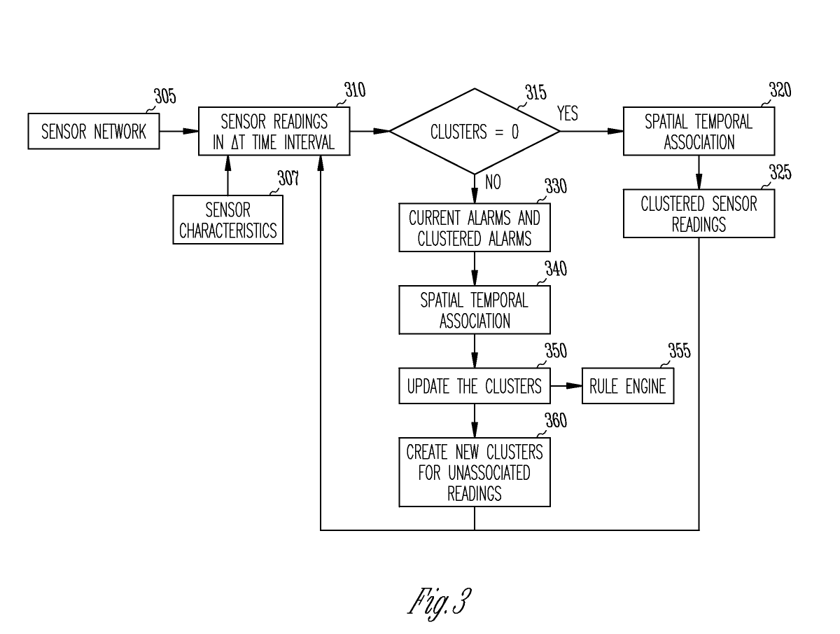

In an embodiment, gating thresholds are varied according to sensor coverage and response times for each sensor. The complete flow of data association is illustrated in FIG. 3. Once an intruder enters an area that is monitored by a sensor network 305, each sensor starts providing readings if the intruder or object is within the field of coverage of that particular sensor. These readings are sent to a central station at 310. The central station has access to the sensor characteristics 307 of each sensor or type of sensor. Data association is performed on the received readings every ΔT seconds. Each time ΔT is checked at 315 to determine whether any previous associated readings are present. If there are no old associated readings, then at 320, spatial-temporal association is performed on the new readings in order to create new clusters at 325. Otherwise, if there are old associated readings (i.e., current alarms and clustered alarms 330), the new readings are checked to determine if they are closer to old clusters both in the spatial and the temporal domain. If the new readings are closer to the old clusters, then those readings are associated to that respective cluster. Otherwise, new clusters are created for the unassociated readings. Updated clusters 350 are sent to a rules engine 355 for decision making. New clusters for the unassociated sensor readings are created at 360. Old clusters are removed from the data base after some time. Spatial and temporal association 340 is done in two ways. A first manner is gating-based association and a second manner is probability-based association. The details of these associations and the inputs for the data association algorithms are disclosed in the following paragraphs.

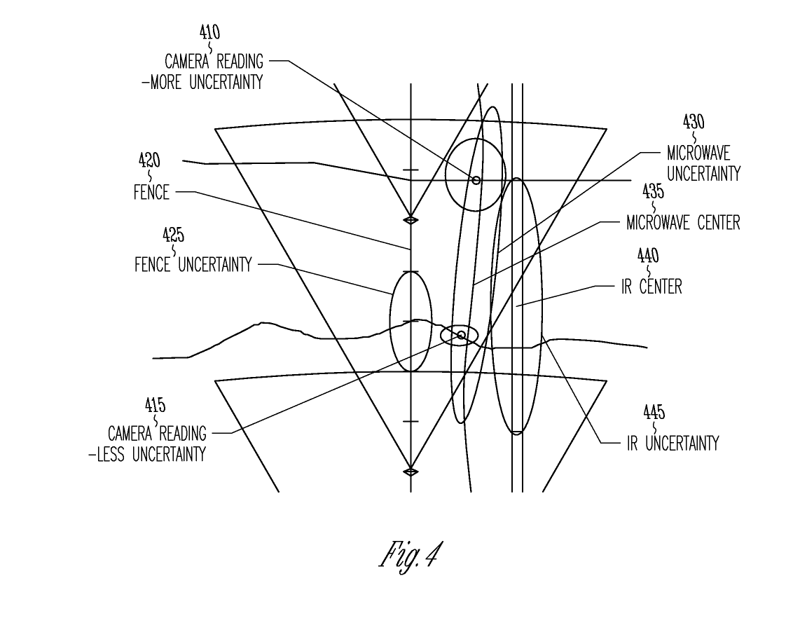

In real time, sensor readings are associated with some spatial error with respect to the actual location. For sensors like cameras, this uncertainty varies with the distance of the object from the sensor due to the perspective of the camera. Sensors like microwave barriers, IR barriers, and fence sensors do not provide an exact location of the object. Rather, the ID of the sensor is sent to the central station. Consequently, the uncertainty for microwave, IR, and fence barriers is the entire spatial region covered by the particular sensor at issue. Spatial uncertainty regions are shown for different sensors in FIG. 4. Specifically, FIG. 4 illustrates that there is more camera uncertainty at 410 and less camera uncertainty at 415. For the fence 420, there is spatial uncertainty 425 around the vibration sensor placed at regular intervals on the fence. FIG. 4 also illustrates a microwave center 435 and an IR center 440, and microwave uncertainty 430 and IR uncertainty 445.

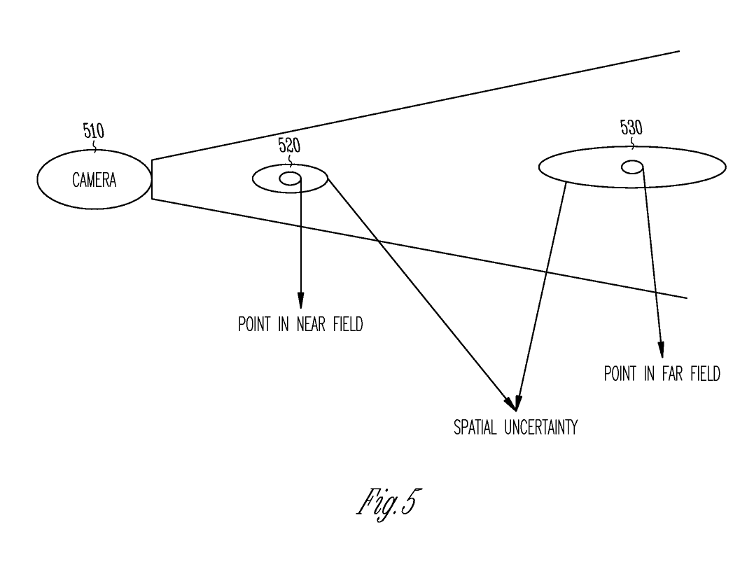

For RADAR, the bearing and range errors are assumed to be constant over the near field region and the far field region. Consequently, spatial uncertainty is taken as constant for the sensor readings obtained from RADAR. As illustrated in FIG. 5, spatial uncertainty for a camera 510 is calculated using the camera's intrinsic and extrinsic parameters. Due to projective geometry, the spatial error is more for the far field objects at 530 than the near field objects at 520 when the error is mapped to world coordinates as shown in FIG. 5.

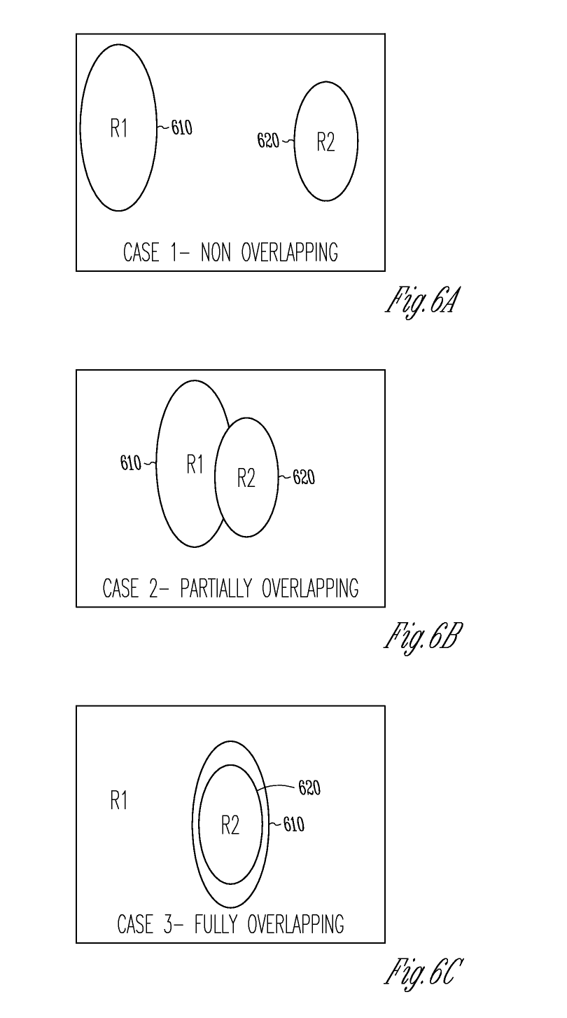

The covariance on spatial error is computed and used as a spatial uncertainty region in data association. In the case of a fence, there are vibration sensors installed on the fence every 10 meters or so. These sensors capture the vibration if any intruder touches the fence. Generally, in the case of fence sensors, spatial uncertainty is taken to be 10 meters on both sides of the vibration sensor along the fence. Spatial uncertainty is only in one dimension (that is, either in the x or in the y direction). In the case of a microwave sensor, the specific location of an intruder is not given by the system. The microwave sensor just provides its sensor ID. Consequently, spatial uncertainty spans the total coverage of a microwave sensor. Similarly, an IR barrier provides its ID, and the spatial uncertainty for the IR barrier is also computed. FIGS. 6A, 6B, and 6C illustrate three types of spatial overlapping between uncertainty regions 610, 620—non-overlapping, fully overlapping, and partially overlapping.

Temporal uncertainty varies for each sensor based on the amount of analytics running on the data that is provided by each sensor. Generally fence, microwave, and IR barriers have less temporal uncertainty because of their fast responses. Since cameras and radars are used for other purposes such as object classification, the uncertainty associated with cameras and radars (for fast moving objects for example) depends on the amount of analytics running on the device.

Spatial uncertainty is two dimensional. Error covariance of each sensor is computed based on the sensor type and the location of the object. The distance between two uncertainty regions is computed using two distance methods. The Euclidean method uses (x1,y1) as the location of sensor reading No. 1 and (x2,y2) as the location of sensor reading No. 2. The distance is then sqrt((x1−x2)̂2+(y1−y2)̂2). The expected distance method uses (x1,y1) as location of sensor reading No. 1, and cov1 as the error covariance of the sensor. The expected distance method further uses (x2,y2) as the location of sensor reading No. 2, cov2 as the error covariance of the sensor. The expected distance is then sqrt((x1−x2)̂2+(y1−y2)̂2+trace(cov1)+trace(cov2)).

Temporal distance on the other hand is one dimensional. The error variance of each sensor is computed based on sensor type. Once again, temporal distance between two uncertainty intervals is computed using two distance methods. For a Euclidean distance, (T1−ΔT1, T1+ΔT1) is the interval of the first reading and (T2−ΔT2, T2+ΔT2) is the interval of the second reading. Two sensor intervals are sampled such that the number of samples in the two intervals is the same. Then, the distance=sqrt(sum(samples of T1−samples of T2)̂2)/length(samples of T1). For the expected distance, (T1−ΔT1, T1+ΔT1) is the interval of the first reading and (T2−ΔT2, T2+ΔT2) is the interval of the second reading. Then, the expected distance is sqrt(T1−T2)̂2+sigma1̂2+sigma2̂2).

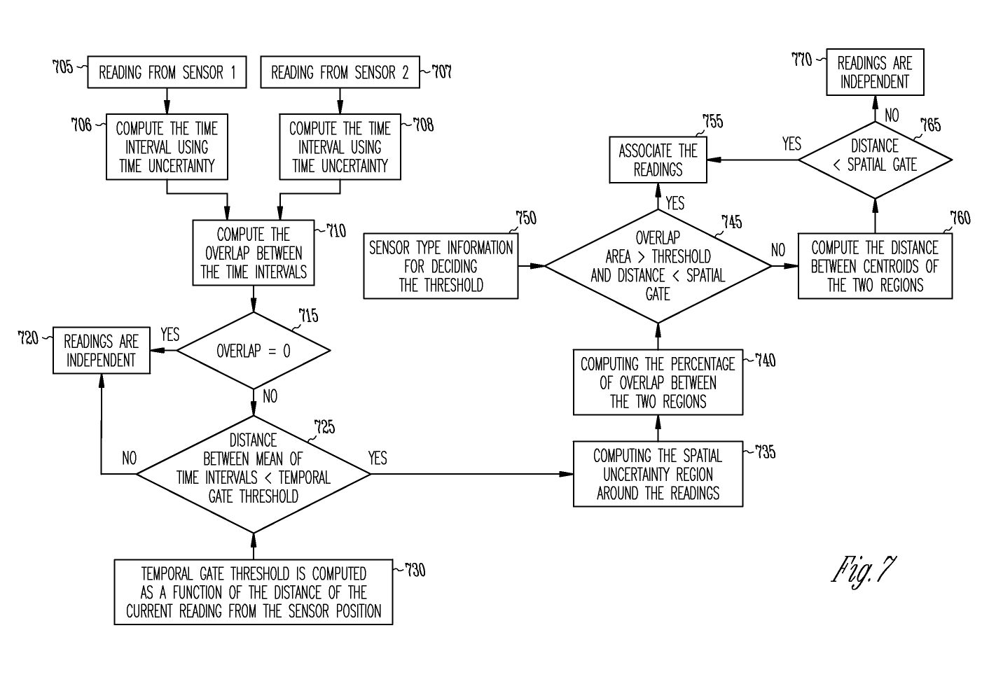

A gating-based data association algorithm mainly relies on the distance between the sensor readings, how close the sensor readings are, and how many readings fall within the spatial or temporal gate of the particular sensor reading. FIG. 7 illustrates a complete operation flow of the gate-based association.

Referring to FIG. 7, readings from a first Sensor 1 are received at 705 and readings from a second Sensor 2 are received at 707. The time interval is computed using the time uncertainty at 706, 708. At 710, the overlap between the two computed time intervals is computed at 710. At 715, if there is no overlap, then the two readings are independent. If there is overlap, than it is determined at 725 if the distance between the mean of the time intervals is less than a temporal gate threshold. The temporal threshold is computed as a function of the distance of current readings from the sensor position. If the mean is not less than the threshold, then as indicated at 720 the readings are independent. If the mean is less than the threshold, then the spatial uncertainty region around the readings is calculated at 735 and the percentage of overlap between the two regions is calculated at 740. The sensor type information for providing the threshold is provided at 750, and at 745, if the overlap area is greater than the threshold and the distance is less than the spatial gate, then the readings are associated at 755. If the test at 745 is negative, the distance between centroids of the two regions is computed at 760. If the computed distance is less than the spatial gate at 765, then the readings are associated at 755, and if not, the readings are determined to be independent at 770.

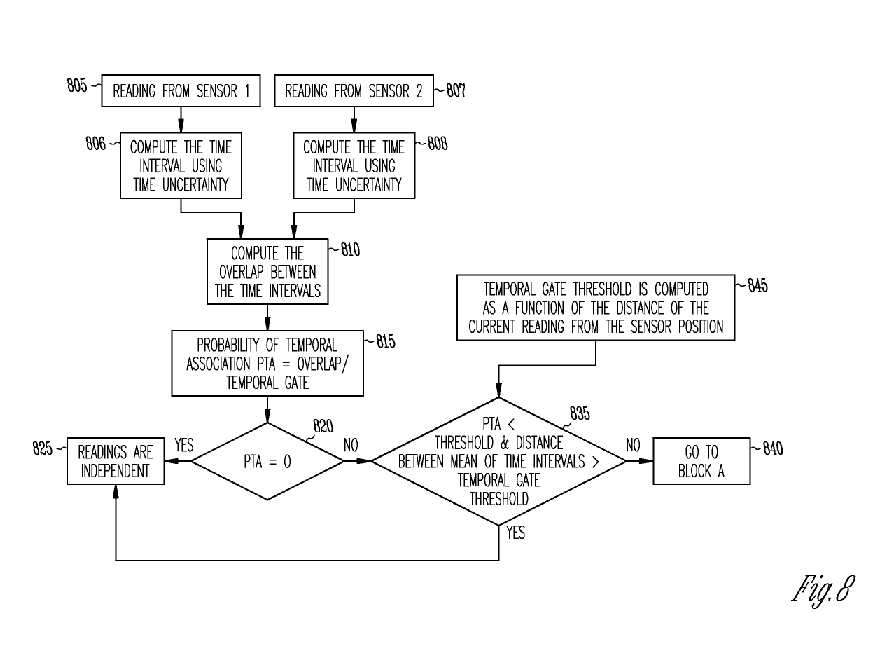

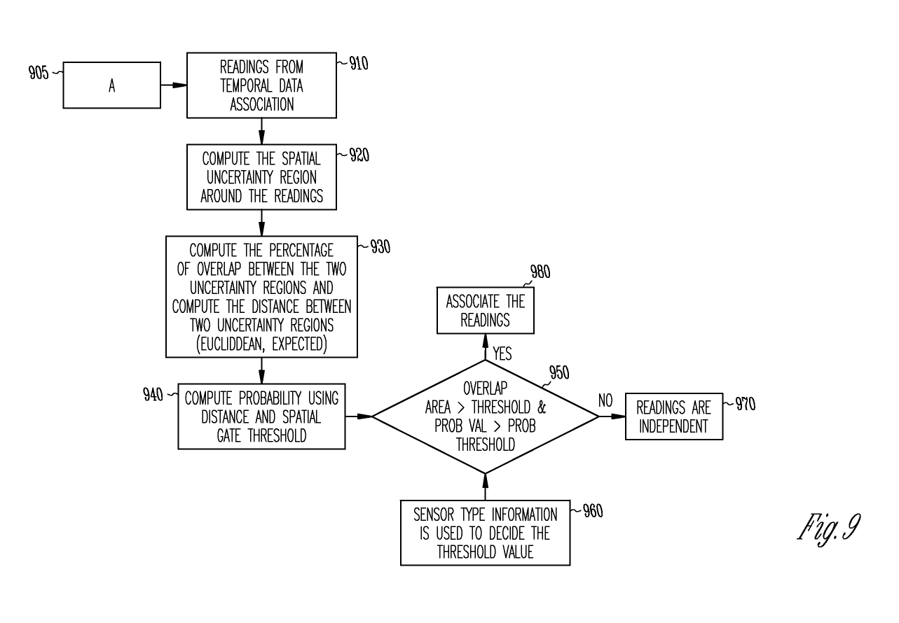

A probability-based association algorithm converts the distance between readings to probability values, and association is then based on these probability values. Computation of probability values for two different distance methods is given below. The Euclidean distance is calculated as follows. The distance equals sqrt((x1−x2)̂2+(y1−y2)̂2). If the Euclidean distance is less than the spatial gate threshold, then the probability value is equal to 1−(Euclidean distance/spatial gate threshold). Otherwise, the probability value is set equal to zero (0). The expected distance is calculated as follows—(mean2(1)−mean1(1))̂2+(mean2(2)−mean1(2))̂2+trace(cov1)+trace(cov2). If the expected distance is less than the spatial gate threshold, then the probability value is set to 1−(expected distance/spatial gate threshold). Otherwise, the probability value is set to zero (0). Probability values for temporal distances are similarly computed. In the process of data association, a reading is associated with another reading or cluster only if the distance between their mean values is less than a threshold and the probability value is greater than a threshold. FIG. 8 illustrates an operation of temporal data association and FIG. 9 illustrates an operation of spatial data association.

Referring specifically to FIG. 8, readings from a first and second sensor are received at 805, 807, and a time interval is computed using the time uncertainty at 806, 808. At 810, the overlap between the two time intervals is computed, and at 815, the probability of temporal association is computed by dividing the overlap by the temporal gate. If it is determined at 820 that the probability of temporal association is equal to zero (0), then the readings are noted as independent at 825. If the probability of temporal association is not equal to zero, then at 835 it is determined if the probability of temporal association is less than a threshold and if the distance between the mean of the time intervals is greater than the temporal gate threshold. At 845, the temporal gate threshold is computed as a function of distance of current reading from the sensor position. If the test is positive at 835, then the readings are marked as independent at 825. If the test is negative at 835, then the process proceeds to Block A at 840, 905.

Referring to FIG. 9, at 910, readings are acquired from temporal data association. At 920, the spatial uncertainty region is computed around the readings. At 930, the percentage of overlap between the two uncertainty regions is computed and the distance (Euclidean, Expected) between the two uncertainty regions are computed. At 940, a probability is computed using the distance and the spatial gate threshold. At 950, it is determined if the overlap area is greater than the threshold and the probability value is greater than the probability threshold. At 960, the sensor type information is used to decide the threshold value. If the test at 950 is positive, then the readings are associated at 980. If the test at 950 is negative, the readings are independent.

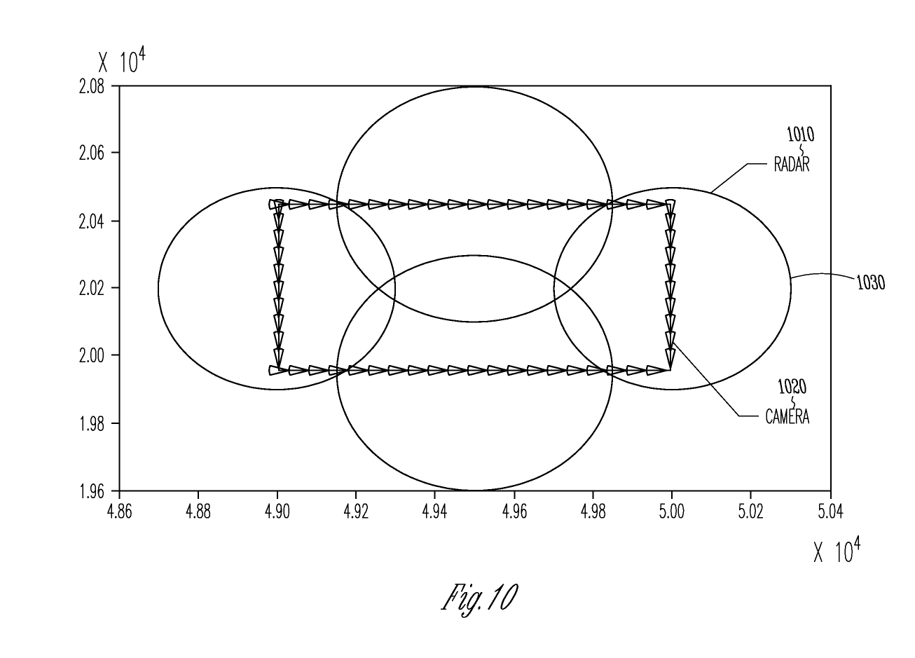

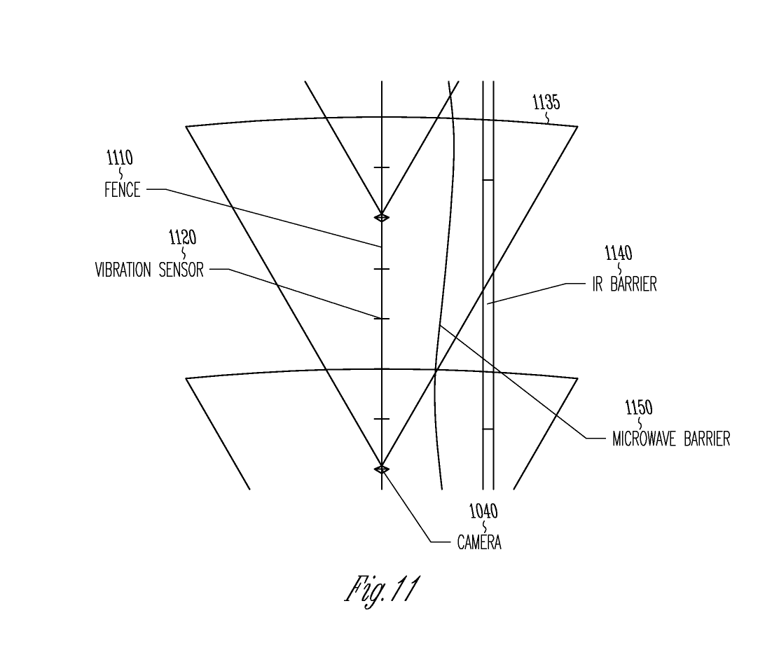

An example perimeter intrusion detection system is illustrated in FIGS. 10 and 11. The example system includes five different types of sensors—RADAR, camera, fence, microwave barrier, and an IR barrier. FIG. 10 illustrates the simulated layout. Specifically, FIG. 10 illustrates a perimeter 1040 that includes cameras 1020 and RADAR 1010 with a field of view of 1030. FIG. 11 illustrates a close up view of the simulation. Specifically, FIG. 11 illustrates a fence 1110 (perimeter 1040) including a vibration sensor 1120, a camera 1040 with a field of view 1135, an IR barrier 1140, and a microwave barrier 1150.

In the example of FIGS. 10 and 11, the simulation perimeter length is 3 kilometers. The simulation perimeter is rectangular (1 km×0.5 km). Four RADAR sensors are used to monitor the perimeter. Specifications of the RADAR are given below.

| | | |
|---|---|---|
| radar01 | obsIntrvl | 2 |
| radar01 | maxRange | 300 |
| radar01 | pMiss | 0.1 |
| radar01 | pClut | 0.1 |
| radar01 | rangers | 5 |
| radar01 | BeamSz | 0.5 |
| radar01 | SigmaXY | 80 |
| radar01 | maxClutLen | 6 |
| radar01 | maxMissLen | 8 |
| radar01 | SigmaQ | 0.0087 |
| radar01 | SigmaR | 100 |
| radar01 | SigmaTheta | 0.0087 |
| radar01 | SigmaRerr | 10000 |
| radar01 | SigmaBerr | 7.57E−05 |

Sixty cameras 1040 are used in the example of FIGS. 10 and 11 to cover the complete perimeter. The range of the camera in the vertical direction is 70 meters and in the horizontal direction the range is 12 meters. In the example, the focal length of the cameras is 35 millimeters and the elevation of the cameras is 10 degrees. Specifications of the camera are provided in the table below.

| | | | |
|---|---|---|---|
| video01 | obsIntrvl | 0.5 | |
| video01 | maxRange | 70 | |
| video01 | horLmt | 77 | 103 |
| video01 | rangers | 100 | |
| video01 | horRes | 100 | |
| video01 | SigmaXY | 80 | |
| video01 | FocalLen | 0.035 | |
| video01 | Elevation | 10 | |
| video01 | SigmaQ | 0.0087 | |
| video01 | SigmaR | 100 | |
| video01 | SigmaTheta | 0.0087 | |
| video01 | SigmaRerr | 10000 | |
| video01 | SigmaBerr | 7.57E−05 | |

Sixty one microwave bathers 1150 are used in the example of FIGS. 10 and 11 to cover the entire perimeter. The distance between the transmitter and receiver of each unit is taken as 60 meters and the maximum horizontal coverage is taken as 3 meters. Sixty infrared bathers 1140 are used in the example of FIGS. 10 and 11 to cover the entire perimeter. The distance between transmitter and receiver of each unit is taken as 50 meters and the maximum horizontal coverage is 1 meter.

In the example of FIGS. 10 and 11, RADAR alarms are generated. Also, with some time gap, alarms are generated on camera, fence, microwave barrier, and IR barrier sensors in sequence within a neighborhood region of the RADAR alarm expecting that the intruder will enter into other sensor regions within the neighborhood of the previous sensor. These are considered as true alarms. Alarms from five sensors are considered as one true intrusion.

Within a time interval of 100 seconds, 100 true intrusions were generated by selecting randomly one time stamp from a 0-100 seconds range. This time stamp is given to radar reading, and then a random location is selected on a tripwire drawn in the RADAR field of view and subsequently an alarm location is selected randomly from the points on the tripwire of camera that are within the neighborhood of the radar alarm. Its time stamp is calculated by taking the distance between radar alarm and camera alarm locations and velocity of the intruder into consideration. In the example, the velocity of the intruder is randomly selected out of a set of values. In the example of FIGS. 10 and 11, velocity values of 2, 5, 7, and 9 meters per second were selected. Similarly, alarm locations and timestamps on fence, microwave barrier, IR barrier are computed. Each sequence of five alarms is considered as one true intrusion. At the same time, it is assumed that each sensor creates false alarms with a probability of 0.01.

In this example, the time gate threshold was considered as 4 seconds and the spatial gate threshold was considered as 10 meters. The distance between the camera and RADAR trip wires was 2 meters, the distance between the camera and fence was 2 meters, the distance between the fence and microwave barrier was 2 meters, and the distance between the IR barrier and the microwave barrier was 2 meters. Some alarms from the true alarms are removed because it was assumed that the detection rate of each sensor is 95%. Once the detected alarms and false alarms were obtained, data association was computed on the complete set of alarms. Each intrusion belongs to single cluster. Since false alarms are random, each false alarm corresponds to a single cluster.

True intrusions and false intrusions are provided to the data association algorithm. Two types of approaches are tested for association. The first type of association is a gating-based approach with two types of distance methods (Euclidean and expected distances). The second type of association is a probabilistic-based approach with two types of distance methods (Euclidean and expected distances). In both of the methods, overlap between the spatial and temporal uncertainty regions of the sensor readings and also overlap between the spatial and temporal distance between sensor readings are used for association.

Data association performance metrics are generated using Hungarian algorithm and average intrusion accuracy. Two metrics are used to quantify the performance of the data association algorithm. One is sequence intrusion detection accuracy (SIDA) and another one is average intrusion accuracy (AIA). In the process of computing SIDA, the intrusion that is closest to the detected cluster must be determined This is accomplished by using the Hungarian algorithm. The association matrix is computed using Equation No. 1. Then the Hungarian algorithm is used to find the best associates for each intrusion from the detected clusters. An association matrix as illustrated in FIG. 11 and as explained in the following paragraph can be used in connection with these performance metrics.
Tintersect(i, j)—number of alarms in intrusion ‘i’ present in cluster ‘j’
Tunion(i, j)—union of alarms in intrusion ‘i’ and cluster ‘j’

Value(i,j)=Tintersect(i,j)/Tunion(i,j) Equation No. 1

The Hungarian algorithm is used to compute the best mapping between the intrusions and clusters. The association values for each best matching pair are used to compute the sequence intrusion detection accuracy (SIDA). If there are ‘N’ intrusions, then ‘N’ mapped values are obtained.

SIDA=Σᵢ₌₁^{Nmapped}Tintersect(lᵢ,mᵢ)/Tunion(lᵢ,mᵢ) Equation No. 2

wherein (lᵢ,mᵢ) is the i^{th} mapping. SIDA is a measure of intrusion performance overall alarms in the sequence. It can take a maximum value of NG, which is the number of ground truth alarms in the sequence. NC is the number of detected alarms in the clusters. Average intrusion accuracy (AIA), which is termed as SIDA per object, is calculated as follows:

$$A I A = \frac{SIDA}{[ \frac{NG + NC}{2} ]} . \qquad Equation No . 3$$

As noted above, FIGS. 13, 14, and 15 provide more detail about the state estimation module 120. The state estimation module 120 decides on the associated sensor readings using a rule based engine 1310. Rule based engine 1310 considers multiple inputs for decision making. These inputs can include threat levels, sensor performance characteristics 1340, topology 1350 and inputs from associated sensor readings 1330 (these are spatially and temporally associated clustered alarms). The rules formulation module 1320 provides further input to the rule based engine 1310, and the output of the rule based engine 1310 in combination with the rules formulation module 1320 are used to determine the existence of an event. In summary, the rule based decision management system of FIG. 13 takes inputs from sensor placement topology (1350), sensor readings (1330), sensor characteristics (1340), threat levels and operator rules (1320) to decide on the outcome (1360). Rule parameters are the triggered sensor readings or individual sensor events, and logical operations on rule parameters constitute a rule.

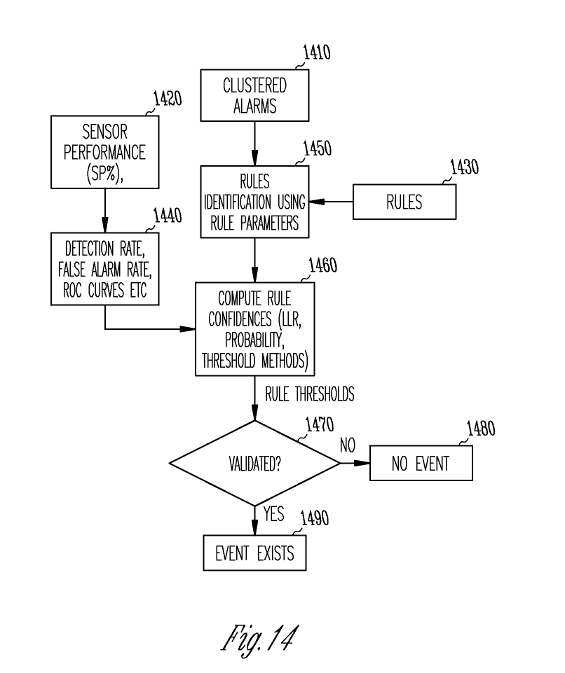

Referring to FIG. 14, this method is a part of State Estimation module of Sensor Fusion Framework. The output of Data Association module is given as input to this module, which is a set of clustered alarms. Sensor performances (1420), which are probabilities of detections or false alarms of the sensors with respect to specific events, are input to this module. These performances (in terms of rates or ROC curves) vary with weather. At the time of installation or later, a set of rules are formulated based on the topology and domain (1430), the rule parameters being sensors triggered. One sample rule can be IF Camera && Fence && Radar THEN Event is Intrusion. As a first step, the sensors of clustered alarms (1410) are extracted and compared to the rules in the rule engine. Specific rules for evaluation are mined or extracted (1450) from the set of rules using the clustered alarms. Rule evaluation is the next step, once the most relevant rule or rules are obtained using the clustered data from data association module. Given the detection rate and false alarm rates (1440) of sensors, methods such as log-likelihood approach or other probability based methods can be used to evaluate the rule through confidence computations (1460). Based on the prior threshold values, the rule confidence values are computed. The computed rule confidence is examined at 1470, and if validated an event exists at 1490, otherwise no event exists at 1480. This output is then logged for input to next module. In the past, the log likelihood ratio (LLR) and other such confidence measures have been computed. In an embodiment, the novelty is using the LLR and such concepts using sensor performances on the rules identified by the cluster alarms. The LLR outcome is used for triggering the rule.

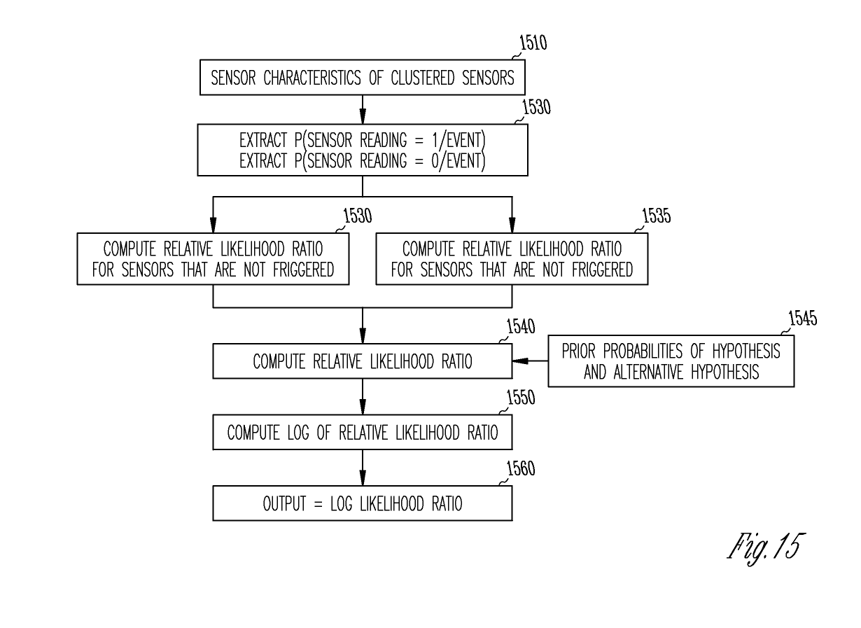

An embodiment of relative log likelihood ratio computation is given in FIG. 15. The concept of this method is that evidence is not only present when sensor readings cross a threshold, but also when other sensors do not trigger for the event. At 1510, sensor characteristics of the clustered sensors are considered. Probability values of sensor reading (1520) when an event happens and those of sensor reading not being present when the event happens are derived or extracted from the sensor characteristics. Relative likelihood is defined as probability ratios of alternative to null hypotheses. In 1530 and 1535, relative likelihood ratio considering derived sensor characteristics are computed for triggered and non-triggered sensors respectively. This information is combined with prior probabilities as indicated at 1545, and Relative Log Likelihood ratio is computed at 1540. This value is compared with a threshold at 1550. A decision 1560 on the state of the clustered alarms is based on the comparison.

As one of the embodiments, the rule based engine does not require sensor ids but only the triggered sensors as rule parameters. This is due to the fact that the rule based engine gets the sensor id information automatically from the clustered alarms (1410). Once a set of alarms are clustered, the rule can be generic, such as event happens if camera and Radar and fence sensors trigger. Primarily this condition holds good for symmetric placement of the sensors along the perimeter as shown in FIG. 10. But in some situations, wherein the rule based engine needs to be used without the clustered alarms as input, it is necessary to mention the sensor ids for rule evaluation. These ids are primarily the sensor ids of those sensors whose FOVs overlap or are adjacent to the position of interest. Otherwise, there can be multiple events occurring in different locations in the perimeter and using the same rule as mentioned above can result in false alarms/incorrect decisions. For this purpose, it is critical either to have rules based on locations of the sensor readings and the sensor types. These rules then become very specific to the deployment topology for having simple and transferrable rules across different deployments of similar placements, it is imperative to derive a method for ease-in-rule formulation. In this context, an embodiment uses topology information to automatic derivation of sub-rules specifying the sensor id, when the higher level rule (example above) is given to the system. This approach reduces the load on the operator to specify each and every sensor id, particularly when there are hundreds of layered sensors.

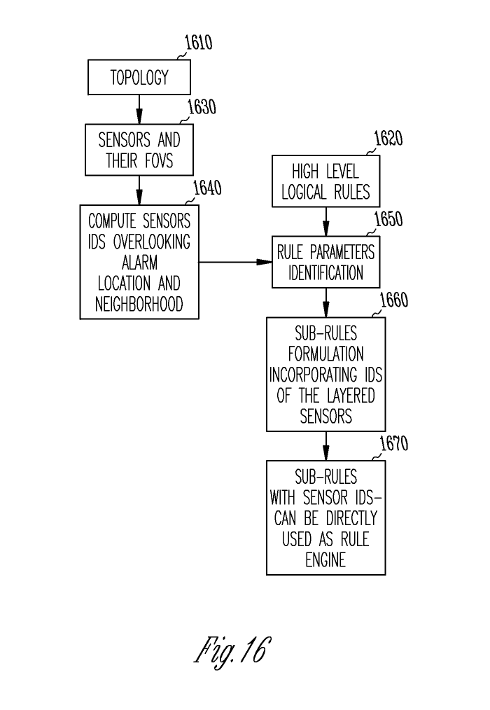

FIG. 16 illustrates a method for rule formulation given the above detailed context. Specifically, a state estimation or simple event detection can use topology and individual sensor alarms or readings based on high level logical rules from which specific rules indicating sensor ids can be derived. More specifically, a rule parameters identification module 1650 receives input from two sources. The module 1650 first receives high level logical rules at 1620. The topology 1610 and sensors 1630 (and the fields of view of the sensors) are used in the computation of alarm location at 1640. At 1660, sub-rules are formulated by incorporating the ids of layered sensors on the rule parameters (sensor types) given by the overlapping sensors (FOV overlap) alarms, and at 1670, the sub-rules with the sensor ids can be directly used in the rule engine whose confidence is computed for decision making. The method of FIG. 16 ensures that sensor ids whose FOVs are overlapping/adjacent are evaluated in a rule-based system. This system is important where there is no prior clustering happening.

The Event Fusion Module 130 consists of a method that takes in simple events detected in a state estimation module 120 along with inputs such as topology of sensor placement, sensor performances and time of events occurrence (150) for determining complex events detection or multi-event detection and their associations. Multiple events occurring at different spatial and temporal instances are combined in this module to indicate overlapping or separate events occurrences. Also, the multiple events occurring separately can be associated into an event network for a specific duration for enhanced situation awareness across the perimeter.

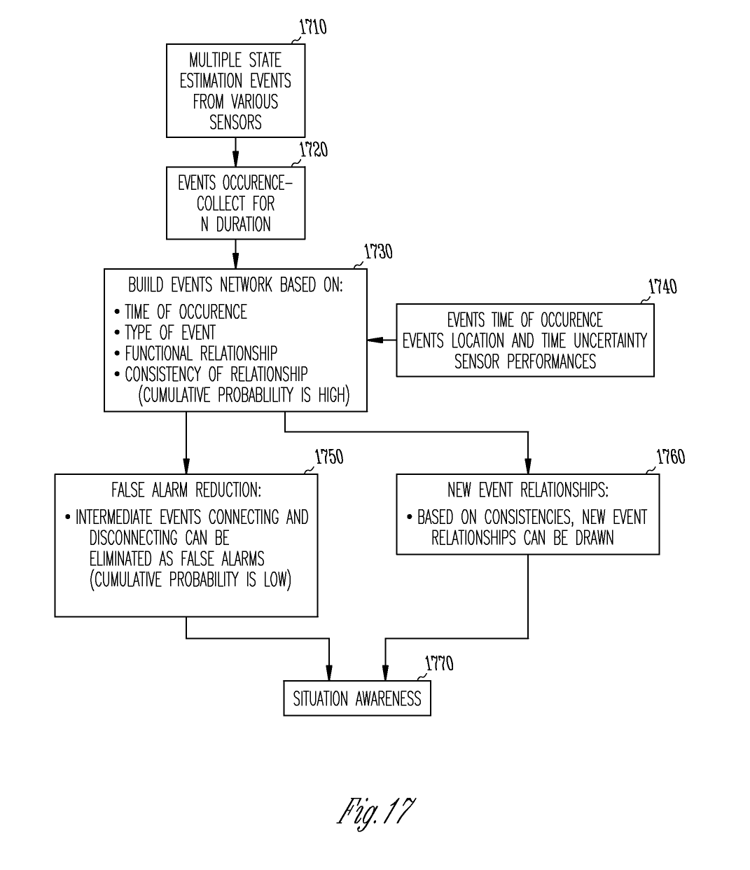

Events occurring at different times and at different spatial locations can be combined to perform activity analysis in and around the perimeter. FIG. 17 illustrates a method that can be used for the event detection module 130. At 1710, multiple state estimation events are received from various sensors. At 1720, events occurrences are collected for a particular duration. At 1730, 1740, an events network is built based on the time of occurrence, the type of event, a functional relationship between the time of occurrence and type of event, and a consistency of the relationship between the time of occurrence and type of event. The events network results in false alarm reduction at 1750, and new event relationships are formed at 1760, which taken together result in an increased situation awareness at 1770. The false alarms are reduced in part because the events network is a dynamic network that changes with the input probabilities. While the dynamic re-structuring of the events network occurs, new relationships may be drawn based on the events.

The events network built with time indicates behavioral patterns of events or intrusions. Some of the methods that could be used for event detection, which is a complex event, and which are derived from simple events detected by the state estimation module 120, are indicated in the sensor fusion framework (110, 120, 130). These are Bayesian Belief Networks, HMM, Static and fuzzy rule based engines (180).

Consequently, a multilevel perimeter protection system has multiple sensors to provide robust security, rather than current systems that concentrate on individual sensors. Embodiments of the present disclosure are concentrated on fusing the alarms from multiple sensors such that the nuisance alarms are mitigated by a large extent and actual alarms are sent to control station. Robust spatio-temporal data association is used, which takes into account sensor characteristics and also uncertainties in spatial and temporal domains. This type of data association is combined with a simple rules engine to achieve better performance than the current individual sensor based alarm system.

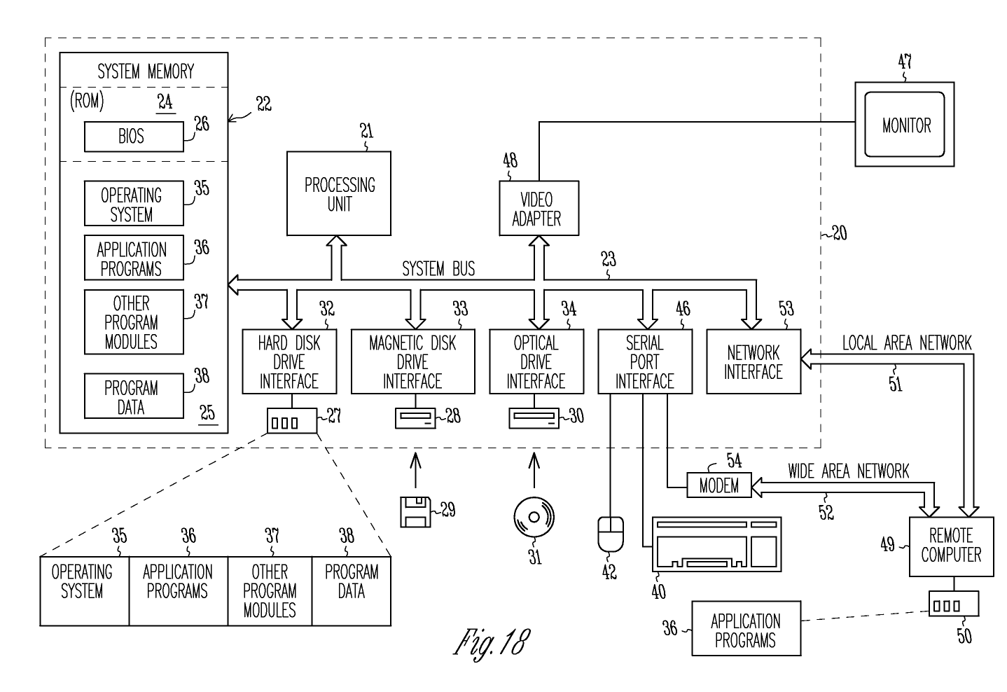

FIG. 18 is an overview diagram of hardware and an operating environment in conjunction with which embodiments of the invention may be practiced. The description of FIG. 18 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/O remote processing devices that are linked through a communications network. In a distributed computing environment, program modules may be located in both local and remote memory storage devices.

In the embodiment shown in FIG. 18, a hardware and operating environment is provided that is applicable to any of the servers and/or remote clients shown in the other Figures.

As shown in FIG. 18, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. A multiprocessor system can include cloud computing environments. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/O relative to the computer 20, although only a memory storage device 50 has been illustrated. The logical connections depicted in FIG. 18 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

It should be understood that there exist implementations of other variations and modifications of the invention and its various aspects, as may be readily apparent, for example, to those of ordinary skill in the art, and that the invention is not limited by specific embodiments described herein. Features and embodiments described above may be combined with each other in different combinations. It is therefore contemplated to cover any and all modifications, variations, combinations or equivalents that fall within the scope of the present invention.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A system comprising:
a plurality of two or more different types of perimeter intrusion detection sensors; and
a computer processor communicatively coupled to the plurality of two or more different types of perimeter intrusion detection sensors;
wherein the computer processor is operable to execute a sensor fusion framework that:
receives event data from the plurality of two or more different types of perimeter intrusion detection sensors;
computes a common location and range uncertainty from the plurality of two or more detection sensors;
clusters the event data from the plurality of two or more different types of perimeter intrusion detection sensors;
analyzes the clustered event data based on different sensor performance characteristics;
generates a single alarm from the clustered data when the clustered data indicates a breach of a perimeter associated with the perimeter intrusion detection sensors; and
provides situation awareness based on alarms generated across the perimeter.

2. The system of claim 1, wherein the computer processor is operable to:
determine an alarm or non-alarm state of the sensors considering the clustered data using one or more of a rule-based engine, a fuzzy rules-based engine, and Bayesian processing; and
provide perimeter breach using one or more of a static rule based engine, a fuzzy rule based engine, evidence based reasoning, or a hidden Markov model considering one or more estimated alarms.

3. The system of claim 1, wherein the clustering of the data is based on characteristics of the plurality of perimeter intrusion detection sensors, a mapping of the plurality of perimeter intrusion detection sensors to a global coordinate system, and analytic performance of each type of the plurality of perimeter intrusion detection sensors.

4. The system of claim 1, wherein the clustering of the data comprises associating the data from the plurality of perimeter intrusion detection sensors into a plurality of clusters, analyzing each of the sensor clusters to determine if a true intrusion occurred, and analyzing a detection of multiple simple events to determine a complex intrusion activity occurrence.

5. The system of claim 4, wherein the associating the data is based on a location and time of a detected object, an uncertainty of the location of the detected object, and an uncertainty of the time of the detected object.

6. The system of claim 4, wherein the associating the data comprises converting a spatial mapping and sensor analytics into an uncertainty in a spatial domain and an uncertainty in a temporal domain;
wherein the spatial uncertainty is computed based on a relative location of a detected object in a field of view of the perimeter intrusion detection sensor; and
wherein the temporal uncertainty is computed based on a type of perimeter intrusion detection sensor and the sensor analytics of the sensor.

7. The system of claim 4, wherein the association the data comprises adaptively computing a temporal gate based on each type of sensor and adaptively computing a spatial gate based on each type of sensor based on time and distance.

8. The system of claim 4, wherein the associating the data comprises computing a distance between sensor readings using spatial and temporal uncertainty for a gating-based association.

9. The system of claim 1, wherein the clustering of the data from the plurality of two or more different types of perimeter intrusion detection sensors comprises:
marking two or more sensor readings as independent when there is no overlap in a time interval of the two or more sensor readings;
computing spatial uncertainty regions around the two or more sensor readings with overlapping time intervals;
determining if there is an overlap among the uncertainty regions; and
associating the two or more sensor readings when the overlap is greater than a threshold.

10. The system of claim 10, wherein a determination of the overlap in the time interval further comprises:
determining a metric of temporal association by dividing the overlap by a temporal gate; and
marking the two or more sensor reading as independent when the metric of temporal association is equal to zero.

11. The system of claim 2, wherein the estimation of alarm state of sensors comprises:
evaluating the clustered sensor data through a rule based engine;
computing a rule confidence of clustered sensor data based on sensor characteristics, topology using log-likelihood, missed detection, and other probability based approaches;
marking the fused sensor data as alarms or non-alarms based on the computed rule confidence; and
mapping the alarms detected as simple events.

12. The system of claim 2, wherein the estimation of alarm state of the system comprises:
evaluating the fused sensor data through characteristics, topology using log-likelihood, missed detection, and other probability based approaches;
marking the fused sensor data as alarms or non-alarms based on a computed confidence; and
mapping the alarms detected as simple events.

13. The system of claim 1, wherein the sensor performance characteristics are detection and false alarm rates of the sensor or receiver operating characteristic (ROC) curves that change with environment or object properties.

14. The system of claim 2, wherein the rule base parameters comprise triggered sensors or triggered sensor values and the rule outcome comprises a simple event including an intrusion or a cross of a boundary.

15. The system of claim 2, wherein topology defines a placement and orientation of sensors in a facility through fields of view descriptions of the sensors.

16. The system of claim 2, wherein the state estimation or simple event detection uses topology and individual sensor alarms or readings based on high level logical rules from which specific rules indicating sensor ids can be derived.

17. The system of claim 1, wherein the situation awareness comprises:
collecting abnormal events occurring over a period of time;
building an events network using time of event occurrence, type, functional relationship, and consistency of relationship;
reducing false alarms in the connected events based on cumulative probability of the events considered; and
discovering new event relationships from the events network based on relationship consistency using confidences.

18. A process for executing a sensor fusion framework comprising:
receiving data from a plurality of two or more different types of perimeter intrusion detection sensors;
fusing the data from the plurality of two or more different types of perimeter intrusion detection sensors;
generating a single alarm from the fused data when the fused data indicates a breach of a perimeter associated with the perimeter intrusion detection sensors; and
providing situation awareness based on alarms generated across the perimeter.

19. A computer readable medium comprising instructions that when executed by a processor execute a process comprising:
receiving data from a plurality of two or more different types of perimeter intrusion detection sensors;
fusing the data from the plurality of two or more different types of perimeter intrusion detection sensors;
generating a single alarm from the fused data when the fused data indicates a breach of a perimeter associated with the perimeter intrusion detection sensors; and
providing situation awareness based on alarms generated across the perimeter.
